(19) United States
(12) Patent Application Publication
(10) Pub. No.: US 2012/0102411 A1
(43) Pub. Date: Apr. 26, 2012

(54) METHOD AND APPARATUS FOR MONITORING USER INTERACTIONS WITH SELECTABLE SEGMENTS OF A CONTENT PACKAGE

(75) Inventor: Sailesh Kumar Sathish, Tampere (FI)

(73) Assignee: Nokia Corporation

(21) Appl. No.: 12/911,103

(22) Filed: Oct. 25, 2010

(51) Int. Cl. G06F 3/01

(52) U.S. Cl. 715/745

(57) ABSTRACT

An apparatus may include a content package selector configured to provide for selection of a content package including one or more selectable segments. A monitoring module may be configured to insert a script into the content package. Further, the monitoring module may monitor one or more user interactions with the selectable segments as directed by the script. The apparatus may further determine one or more contextual characteristics relating to the user interactions. Thereby, the user interactions, the contextual characteristics, and/or the selectable segments may be stored and/or transmitted so as to build a data model based thereon. The data model may be used to make content recommendations based on the monitored user interactions and determined contextual characteristics as they related to the user interaction events with the selectable segments of the content package.

### TECHNOLOGICAL FIELD

An example embodiment of the present invention relates generally to techniques for monitoring user interactions with selectable segments of a content package and, more particularly, relates to an apparatus, a method and a computer program product for monitoring user interactions with the selectable segments and monitoring event circumstances relating to the user interactions.

### BACKGROUND

In order to provide easier or faster information transfer and convenience, telecommunication industry service providers are continually developing improvements to existing communication networks. As a result, wireless communication has become increasingly more reliable in recent years. Along with the expansion and improvement of wireless communication networks, mobile terminals used for wireless communication have also been continually improving. In this regard, due at least in part to reductions in size and cost, along with improvements in battery life and computing capacity, mobile terminals have become more capable, easier to use, and cheaper to obtain. Due to the now ubiquitous nature of mobile terminals, people of all ages and education levels are utilizing mobile terminals to communicate with other individuals or contacts, receive services and/or share information, media and other content.

Some of the technologies which are becoming more popular are that of location based services and other personalized services. In this regard, some technologies may provide users of properly equipped mobile terminals with content which is specific to the present location of the user, present activity of the user, or other contextual information. Thus, for example, the user may be provided with weather information relating to the user's present location. In other instances the user may be provided with information such as Uniform Resource Locators (URLs) which relate to one or both of the user's interests and the user's present location along with other contextual characteristics. Thereby, content may be provided to the user automatically which may be relevant to the user's interest and current context. This content may in some cases be displayed on the home screen of the mobile terminal.

### BRIEF SUMMARY

A method, apparatus and computer program product therefore provide for monitoring user interactions with selectable segments of a content package, and determining contextual characteristics related thereto.

In an example embodiment, an apparatus comprises at least one processor and at least one memory including computer program code, the at least one memory and the computer program code configured to, with the processor, cause the apparatus to provide for selection of a content package comprising one or more selectable segments. The apparatus may insert a script into the content package and monitor one or more user interactions with the selectable segments as directed by the script.

In an additional example embodiment a method comprises providing for selection of a content package comprising one or more selectable segments. Further, the method may include inserting a script into the content package, and monitoring one or more user interactions with the selectable segments via a processor as directed by the script.

In a further example embodiment a computer program product comprises at least one computer-readable storage medium having computer-executable program code portions stored therein, the computer-executable program code portions comprising program code instructions providing for selection of a content package comprising one or more selectable segments. Further, the computer program product may include program code instructions for inserting a script into the content package. Additionally, the computer program product may include program code instructions for monitoring one or more user interactions with the selectable segments as directed by the script.

In a further example embodiment an apparatus comprises means providing for selection of a content package comprising one or more selectable segments. Further, the apparatus may include means for inserting a script into the content package, and means for monitoring one or more user interactions with the selectable segments as directed by the script.

In some embodiments a request for monitoring the user interactions may be received from an application, and the script may be drafted based on the request. Further, a second request for monitoring the user interactions may be received from a second application, and thereby the script may be drafted based on both the request and the second request. The script may be inserted into the content package after the content package is selected. Also, one or more contextual characteristics relating to the user interactions may be determined. Thus, at least one of the user interactions, the contextual characteristics, and the selectable segments may be transmitted, in one embodiment.

Additionally, a data model may be built based at least in part on one or more of the user interactions, the contextual characteristics, and the selectable segments. User interface circuitry may also be provided which is configured to facilitate user control of at least some functions through use of a display. The user interface circuitry may cause at least a portion of a user interface to be displayed on the display to facilitate user control of at least some functions. Accordingly, embodiments of the present invention may provide a way to build data models based on user interactions with selectable segments of a content package, and accordingly content recommendations may be improved.

### BRIEF DESCRIPTION OF THE SEVERAL VIEWS OF THE DRAWING(S)

Having thus described embodiments of the present disclosure in general terms, reference will now be made to the accompanying drawings, which are not necessarily drawn to scale, and wherein:

FIG. 1 illustrates a schematic block diagram of a system according to an example embodiment of the present invention;

FIG. 2 illustrates a schematic block diagram of an apparatus configured to monitor one or more user interactions with selectable segments of a content package according to an example embodiment of the present invention; and

FIG. 3 illustrates a flowchart of the operations performed in monitoring one or more user interactions with selectable segments of a content package according to an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as may be used herein, is not provided to convey any qualitative assessment, but instead merely to convey an illustration of an example. Thus, use of any such terms should not be taken to limit the spirit and scope of embodiments of the present invention.

As used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

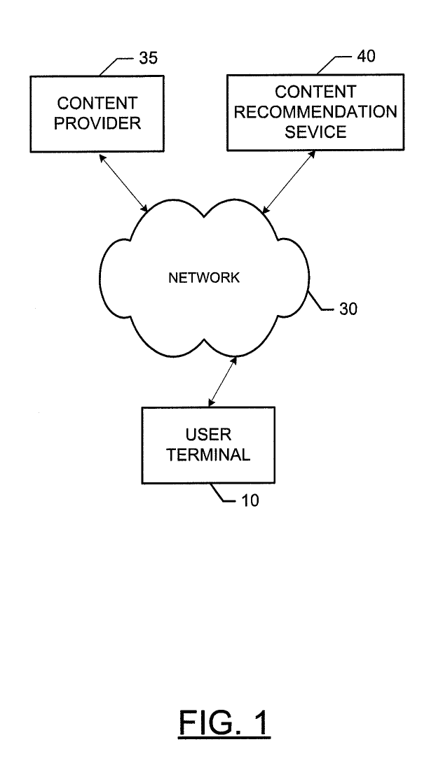

As indicated above, some embodiments of the present invention may be employed in methods, apparatuses and computer program products configured to monitor user interactions with selected content. In this regard, for example, FIG. 1 illustrates a block diagram of a system that may benefit from embodiments of the present invention. It should be understood, however, that the system as illustrated and hereinafter described is merely illustrative of one system that may benefit from an example embodiment of the present invention and, therefore, should not be taken to limit the scope of embodiments of the present invention.

As shown in FIG. 1, a system in accordance with an example embodiment of the present invention may include a user terminal 10. The user terminal 10 may be any of multiple types of fixed or mobile communication and/or computing devices such as, for example, personal digital assistants (PDAs), pagers, mobile televisions, mobile telephones, gaming devices, laptop computers, personal computers (PCs), cameras, camera phones, video recorders, audio/video players, radios, global positioning system (GPS) devices, or any combination of the aforementioned, which employ an embodiment of the present invention.

In some embodiments the user terminal 10 may be capable of communicating with other devices, either directly, or via a network 30. The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like. Thus, the network 30 may be a cellular network, a mobile network and/or a data network, such as a local area network (LAN), a metropolitan area network (MAN), and/or a wide area network (WAN), for example, the Internet. In turn, other devices such as processing elements (for example, personal computers, server computers or the like) may be included in or coupled to the network 30. By directly or indirectly connecting the user terminal 10 and the other devices to the network 30, the user terminal and/or the other devices may be enabled to communicate with each other, for example, according to numerous communication protocols including Hypertext Transfer Protocol (HTTP) and/or the like, to thereby carry out various communication or other functions of the user terminal and the other devices, respectively. As such, the user terminal 10 and the other devices may be enabled to communicate with the network 30 and/or each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as wireless LAN (WLAN), Worldwide Interoperability for Microwave Access (WiMAX), WiFi, ultra-wide band (UWB), Wibree techniques and/or the like and fixed access mechanisms such as digital subscriber line (DSL), cable modems, Ethernet and/or the like. Thus, for example, the network 30 may be a home network or other network providing local connectivity.

The user terminal 10 may be configured to output URL links and/or other types of content such as pictures, data, audio, or video for selection by the user. Thus, the system may additionally comprise one or more content providers 35 which provide the content to the user terminal 10. In some embodiments each of the content providers 35 may be embodied as a server, server bank or other computer or other computing device or node configured to provide content to the user terminal 10. Each content provider 35 may have any number of functions or associations with various services. As such, for example, each of the content providers 35 may be a platform such as a dedicated server (or server bank), or each of the content providers may be a backend server associated with one or more other functions or services. Thus, the content providers may provide various types and forms of content to the user terminal 10.

In some embodiments content may be recommended to the user of the user terminal 10 by a content recommendation service 40. For example, the content may be selected for recommendation based on contextual characteristics and/or user preferences. Contextual characteristics may include the present time, location, activity, etc. of the user and/or the user terminal 10. User preferences may relate to the particular user of the user terminal. For example, the user preferences may indicate that the user is interested in world news in the evenings. User preferences may be inputted by the user directly and/or inferred from user behavior, for example, in relation to the recommended content. Therefore, by way of example, the content recommendation service 40 may provide URLs to the user terminal 10 which relate to the user preferences and/or the contextual characteristics of the user and the user terminal. Further, the user may subscribe to particular channels of content through the content recommendation service 40. For example, a content channel may relate to college sports. Thereby, content may also be provided to the user terminal 10 by the content recommendation service 40 which relates to the particular content channels the user subscribes to.

The content recommendation service 40 may have any number of functions or associations with various services. As such, for example, the content recommendation service 40 may be a platform such as a dedicated server (or server bank), the content recommendation service may be a backend server associated with one or more other functions or services, or the content recommendation service may embody a processor and memory. Thus, the content recommendation service 40 may recommend content for selection by the user.

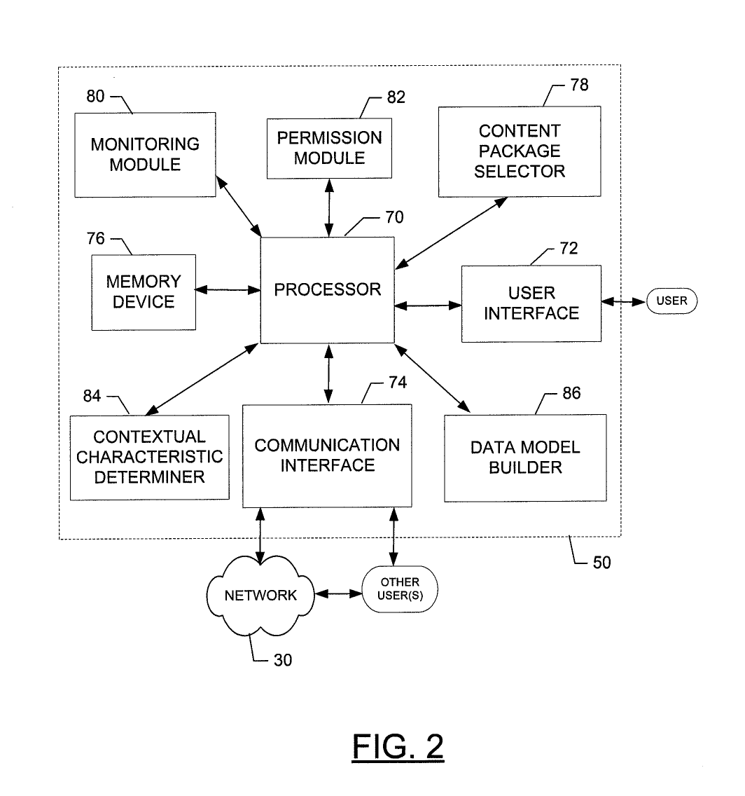

In an example embodiment, an apparatus 50 is provided that may be employed by devices performing example embodiments of the present invention. The apparatus 50 may be embodied, for example, as any device hosting, including, controlling, comprising, or otherwise forming a portion of the user terminal 10, the content providers 35, and/or the content recommendation service 40. However, embodiments may also be embodied on a plurality of other devices such as for example where instances of the apparatus 50 may be embodied on the network 30. As such, the apparatus 50 of FIG. 2 is merely an example and may include more, or in some cases less, than the components shown in FIG. 2.

With further regard to FIG. 2, the apparatus 50 may be configured to monitor user interactions with selectable segments of a content package. The apparatus 50 may include or otherwise be in communication with a processor 70, a user interface 72, a communication interface 74 and a memory device 76. The memory device 76 may include, for example, volatile and/or non-volatile memory. The memory device 76 may be configured to store information, data, files, applications, instructions or the like. For example, the memory device 76 could be configured to buffer input data for processing by the processor 70. Additionally or alternatively, the memory device 76 could be configured to store instructions for execution by the processor 70.

As mentioned above, the apparatus 50 may, in some embodiments, be a user terminal or a fixed communication device or computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 70 may be embodied in a number of different ways. For example, the processor 70 may be embodied as one or more of various processing means such as a coprocessor, a microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a hardware accelerator, a special-purpose computer chip, or other hardware processor. In an example embodiment, the processor 70 may be configured to execute instructions stored in the memory device 76 or otherwise accessible to the processor. Alternatively or additionally, the processor 70 may be configured to execute hard coded functionality. As such, whether configured by hardware or software methods, or by a combination thereof, the processor 70 may represent an entity (for example, physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor to perform the algorithms and/or operations described herein when the instructions are executed. However, in some cases, the processor 70 may be a processor of a specific device (for example, a user terminal or network device such as a server) adapted for employing embodiments of the present invention by further configuration of the processor by instructions for performing the algorithms and/or operations described herein. The processor 70 may include, among other things, a clock, an arithmetic logic unit (ALU) and logic gates configured to support operation of the processor.

Meanwhile, the communication interface 74 may be any means such as a device or circuitry embodied in either hardware, software, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (for example, network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet, High-Definition Multimedia Interface (HDMI) or other mechanisms. Furthermore, the communication interface 74 may include hardware and/or software for supporting communication mechanisms such as BLUETOOTH®, Infrared, UWB, WiFi, and/or the like, which are being increasingly employed in connection with providing home connectivity solutions.

The user interface 72 may be in communication with the processor 70 to receive an indication of a user input at the user interface and/or to provide an audible, visual, mechanical or other output to the user. As such, the user interface 72 may include, for example, a keyboard, a mouse, a joystick, a display, a touch screen, a microphone, a speaker, or other input/output mechanisms.

The processor 70 may comprise user interface circuitry configured to control at least some functions of one or more elements of the user interface 72, such as, for example, the speaker, the ringer, the microphone, the display, and/or the like. The processor 70 and/or user interface circuitry comprising the processor 70 may be configured to control one or more functions of one or more elements of the user interface 72 through computer program instructions (for example, software and/or firmware) stored on a memory accessible to the processor 70 (for example, memory device 76, and/or the like).

In some embodiments the apparatus 50 may further include a content package selector 78. The processor 70 or other circuitry may be embodied as, include or otherwise control the content package selector 78. The content package selector 78 may be configured to provide for selection of a content package. A content package, as used herein, may comprise a plurality of data. In this regard, as noted above, in one embodiment the content recommendation service 40 may recommend content for selection by the user. Thereby, for example, the content package selector 78 may provide a list of URLs for selection by the user which was recommended by the content recommendation service 40. Accordingly, the user may select one or more of the URLs and the content providers 35 may thereby provide the apparatus 50 with the content package relating thereto. Each content package may include one or more selectable segments, which may comprise various additional URLs in some embodiments as well as other content which the user may interact with.

However, the user may also employ the content package selector 78 to select content which is not recommended by the content recommendation service 40. For example, the content package selector 78 may allow the user to search for content which the user is interested in and then view the results. In this instance, the search results list may constitute the content package, and the individual results therein may comprise selectable segments which the user may then select to retrieve more information thereon. For example, the search results may comprise URLs. Thereby, the content package selector 78 may be configured to allow the user to select further selectable segments from within the selected URL in an iterative manner. Thus, the content package may or may not be recommended by the content recommendation service 40 in various embodiments.

In some embodiments the apparatus 50 may further include a monitoring module 80. The processor 70 or other circuitry may be embodied as, include or otherwise control the monitoring module 80. The monitoring module 80 may be configured to insert a script into the content package which is configured to monitor one or more user interaction events with the selectable segments of the content package.

Inserting the script into the content package may employ a variety of techniques in various embodiments. In one example embodiment, the monitoring module 80 may insert the script into the content package after the content package is selected. A browser or other application may be configured to output the content package. Thereby, for example, the script may be loaded through a browser extension plug-in (or other application plug-in, as applicable), and the script may be inserted into the body portion of the content package, e.g. in the <body> tag portion of the content package. By inserting the script in this manner, no additional network traffic may be required because the script is installed by the monitoring module 80, which is internal to the apparatus 50. Further, the content provider 35 may not be affected, because the script is installed at the apparatus 50, rather than on content before it leaves the content providers.

The script inserted by the monitoring module 80 may be configured to monitor one or more user interactions with the selected content. User interactions, as used herein, may refer to user inputs or other interaction with the content package, by a user. User interactions may include standard document object model (DOM) events, through they are not limited thereto. Thus, for example, when a user clicks on a portion of the content package or otherwise interacts therewith, the script may monitor this activity. Conversely, user interactions may also comprise the lack of a user action. For example, if a user does not click-through or otherwise interact with the content package, the script may monitor this lack of activity.

In one embodiment the monitoring module 80 may be configured to search the content package for one or more selectable segments. For example, the monitoring module 80 may locate links and/or other selectable segments which the user may interact with through user interactions. Accordingly, the monitoring module 80 may monitor any such user interactions. Further, in some embodiments the monitoring module 80 may iteratively repeat this process for each selection of a new content package. Notably, without access to the content package as described above, user interactions may only be monitored for the initial selection. For example, once a URL link is linked, control of, and access to the information in the resulting content package may be internal to the browser or other application outputting the content package. Thus, without knowledge of user interactions with the selectable segments of the content package, it may only be known that the user selected the content package. In this regard, by also monitoring user interactions as they occur within the content package and within additional content packages selected therefrom in an iterative manner, significantly more user interactions may be monitored, and thus significantly more information relating to user preferences may be obtained. For example, if a user does not click-through a content package, this may indicate that the user was not interested in the content package. Whereas one or more click-throughs from the content package and/or extended viewing of the content package may indicate that the user was interested in the content package.

In some embodiments the apparatus 50 may further comprise a permission module 82. The processor 70 or other circuitry may be embodied as, include or otherwise control the permission module 82. The permission module 82 may be configured to determine a script permission level. The script permission level may allow or prohibit insertion of the script and/or restrict access to information by the script. For example, in some embodiments the permission module 82 may require granting of user permission prior to allowing a script to be inserted into the content package. In some embodiments user permission may only be required once per service or application. Further, in some embodiments the permission module 82 may require certain credentials from the application or service before the permission module allows the script to be inserted in the content package. In this regard, the permission module may restrict access to user interaction and/or contextual characteristic information to only those applications or services which have permission to do so.

In some embodiments the apparatus 50 may further include a contextual characteristic determiner 84. The processor 70 or other circuitry may be embodied as, include or otherwise control the contextual characteristic determiner 84. Contextual characteristics may include the present time, location, activity, etc. of the user and/or the apparatus 50. Thus, for example, the contextual characteristic determiner 84 may determine that the user is presently at home, at work, or outside walking. Information relating to the location of the user may, for example, be provided by a GPS module, though location information may additionally or alternatively be provided through other means such as triangulation using cell phone towers in some embodiments.

Thus, the apparatus 50 may determine one or more contextual characteristics. The contextual characteristic determiner 84 may work in conjunction with the monitoring module 80 to capture contextual characteristics relating to the user interactions. In this regard, for example, the contextual characteristic determiner 84 may determine contextual characteristics at the time of the user interactions. Thus, the context under which a user interaction occurs may be determined. Conversely, user interactions may be monitored by the monitoring module 80 when the contextual characteristic determiner detects a specified occurrence. For example, the apparatus 50 may be configured (e.g. using the script) such that when the user is at a certain latitude and longitude, as determined by the contextual characteristic determiner 84, the monitoring module 80 may monitor one or more user interaction events with a content package.

In some embodiments the script which is inserted into the content package may specify the parameters under which the contextual characteristic determiner 84 determines the contextual characteristics. In this regard, in some embodiments monitoring of the user interactions and/or the contextual characteristics may occur via direct insertion of the script into the content package by an application which may be executed by the processor 70. However, in other embodiments the monitoring module 80 may be configured to receive a request for monitoring the user interactions and/or related contextual characteristics from the application. The monitoring module 80 may thereby draft the script based on the request. For example, the request may indicate the desired parameters for monitoring/determination. The request may be written in extensible markup language (XML) in some embodiments, although the request may take other forms in other embodiments.

The request may include parameters such as the user interactions to be monitored (as may be selected from standard DOM events in one embodiment), and/or contextual characteristics which are to be determined. In some embodiments the contextual characteristics may be used to specify the conditions under which to monitor the user interactions, as described above. For example, user interactions may only be of interest to a particular application under certain context, and hence occurrence of the specified context, as determined by the contextual characteristic determiner 84, may specify the conditions under which to monitor the user intervention events.

In some embodiments the request from the application (or the directly inserted script) may specify a location for storage of the user interactions which are monitored and/or or the determined contextual characteristics. Thus, the parameters for monitoring the user interactions with the selectable segments, the corresponding contextual characteristics, and/or the location for storage may be included in a directly inserted script, or included in a request registered with the monitoring module 80 by the one or more applications in some embodiments.

The monitoring module 80 may be further configured to receive a second request for monitoring the user interactions and/or determining the related contextual characteristics from a second application. In some embodiments the monitoring module 80 may draft a separate second script based on the second request. However, in other embodiments the monitoring module 80 my draft a single script based on both the request and the second request. Thus, when the monitoring module 80 receives multiple requests, the monitoring module may combine the requests to form a single script in some embodiments.

In one example embodiment the script may comprise a Java script. For example, when dynamically formulated, Data A may be used for specifying the monitoring section of the script. The monitoring section may be used to locate the selectable segments within the content package and add an event listener configured to recognize user interactions therewith. Data B and C may be used to specify the data recorded upon occurrence of a user interaction. For example, the type of contextual characteristics which are to be recorded may be specified in this section. Further, the location to which the captured data log is stored may be specified in this section. Additionally, Data D may be used to specify the application credentials and/or privacy policies pertaining to the apparatus 50 and/or the user. However, various other types and formats of scripts may be employed.

The storage location for the data log may vary in some embodiments. In this regard, in some embodiments the apparatus 50 may provide for storage of data log locally in the memory device 76. In other embodiments the apparatus 50 may provide for storage of the data log in a remote location. For example, the communication interface 74 may provide for transmission of the user interactions, the contextual characteristics, the selectable segments, and/or other information contained in data log, and thus the data log may be stored and/or processed externally from the apparatus 50 in some embodiments.

In some embodiments the apparatus 50 may further include a data model builder 86. The processor 70 or other circuitry may be embodied as, include or otherwise control the data model builder 86. The data model builder 86 may be configured to provide for building a data model based at least in part on one or more of the user interactions, the contextual characteristics, and the selectable segments. For example, the information gathered by the script may be used to build a collaborative data model which may be used to recommend content. Thereby, for example, a matrix factorization model may be built which may recommend content of greater interest to users.

As mentioned above, some or all of the apparatus 50 may be embodied on the user terminal 10. In this regard, the data model builder 86 may build the data model locally on the user terminal 10 in some embodiments. However, as also noted above, in other embodiments some or all of the apparatus 50 may be embodied on the content recommendation service 40. Thereby, for example, the data model builder 86 may be embodied on the content recommendation service 40 and build the data model thereon. The data model builder 86 may be embodied as a processor and memory in some embodiments. Accordingly, in such embodiments the data model may be a shared data model which is configured to recommend content for a plurality of users.

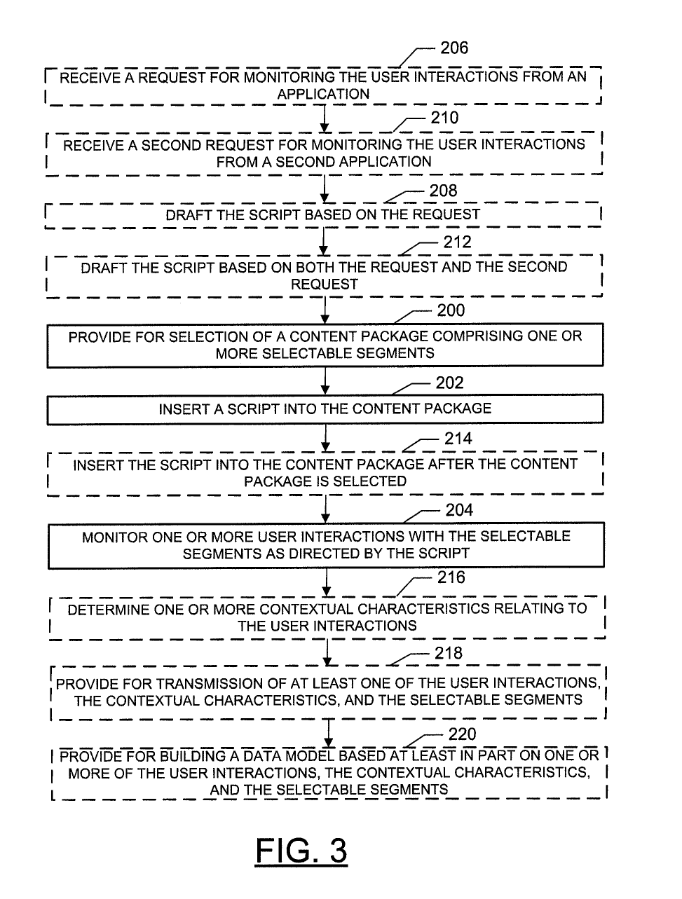

In terms of methods associated with embodiments of the present invention, the above-described apparatus 50 or other embodiments of apparatuses may be employed. In this regard, FIG. 3 is a flowchart of a system, method and program product according to example embodiments of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by a computer program product including computer program instructions. In this regard, the computer program instructions which embody the procedures described above may be stored by a memory device and executed by a processor of an apparatus. As will be appreciated, any such computer program instructions may be loaded onto a computer or other programmable apparatus (for example, hardware) to produce a machine, such that the resulting computer or other programmable apparatus embody means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

In this regard, one embodiment of a method may include providing for selection of a content package comprising one or more selectable segments at operation 200. Further, the method may include inserting a script into the content package at operation 202. Additionally, the method may include monitoring one or more user interactions with the selectable segments as directed by the script at operation 204.

In some embodiments, certain ones of the above-described operations (as illustrated in solid lines in FIG. 3) may be modified or further amplified. In some embodiments additional operations may also be included (some examples of which are shown in dashed lines in FIG. 3). It should be appreciated that each of the modifications, optional additions or amplifications may be included with the above-described operations (200-204) either alone or in combination with any others among the features described herein. As such, each of the other operations as will be described herein may be combinable with the above-described operations (200-204) either alone or with one, more than one, or all of the additional operations in any combination.

For example, the method may also include receiving a request for monitoring the user interactions from an application at operation 206. Thus, the method may further comprise drafting the script based on the request at operation 208. Additionally, the method may include receiving a second request for monitoring the user interactions from a second application at operation 210. Accordingly, the method may include drafting the script based on both the request and the second request at operation 212. However, prior to drafting the script at operations 208 and 212 may not occur until user permission and/or credentials are provided which allow insertion of the script in some embodiments.

In some embodiments inserting the script into the content package at operation 202 may comprise inserting the script into the content package after the content package is selected, as indicated at operation 214. For example, the script may be inserted into the content package at the user terminal 10, as opposed to previously inserting the script into the content package at the content providers 35. Additionally, the method may comprise determining one or more contextual characteristics relating to the user interactions at operation 216. Also, the method may comprise providing for transmission of at least one of the user interactions, the contextual characteristics, and the selectable segments at operation 218. For example, the user terminal 10 may transmit a data log of this information to the content recommendation service 40. Further, the method may include providing for building a data model based at least in part on one or more of the user interactions, the contextual characteristics, and the selectable segments at operation 220. In one embodiment the data model may be built in the user terminal 10, whereas in another embodiment the data model may be built in the content recommendation service 40, for example.

In an example embodiment, an apparatus for performing the method of FIG. 3 and other methods described above may comprise a processor (for example, the processor 70) configured to perform some or each of the operations (200-220) described above. The processor may, for example, be configured to perform the operations (200-220) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 200-220 may comprise, for example, the processor 70, the user interface 72, the communication interface 74, the content package selector 78, the monitoring module 80, the contextual characteristic determiner 84, and/or the data model builder 86, as described above. However, the above-described portions of the apparatus 50 as they relate to the operations of the method illustrated in FIG. 3 are merely examples, and it should be understood that various other embodiments may be possible.

In some embodiments the operation 200 of providing for selection of a content package comprising one or more selectable segments may be conducted by means, such as the content package selector 78, the user interface 72, and/or the processor 70. Further, the operation 202 of inserting a script into the content package and the operation 214 of inserting the script into the content package after the content package is selected may be conducted by means, such as the monitoring module 80, and/or the processor 70. Additionally, the operation 204 of monitoring one or more user interactions with the selectable segments as directed by the script may be conducted by means, such as the monitoring module 80, and/or the processor 70.

Also, the operation 206 of receiving a request for monitoring the user interactions, the operation 210 of receiving a second request for monitoring the user interactions from a second application, the operation 208 of drafting the script based on the request, and the operation 212 of drafting the script based on both the request and the second request may be conducted by means, such as the monitoring module 80, and/or the processor 70. In embodiment in which user permission and/or credentials are required prior to insertion of the script, the permission module 82 may be employed to determine the permission level prior to operations 208, 212 that draft the script. Additionally, the operation 216 of determining one or more contextual characteristics relating to the user interactions may be conducted by means, such as the contextual characteristic determiner 84, the monitoring module 80, and/or the processor 70. Further, the operation 218 of providing for transmission of at least one of the user interactions, the contextual characteristics, and the selectable segments may be conducted by means, such as the monitoring module 80, the contextual characteristic determiner 84, the communication interface 74, and/or the processor 70. Also, the operation 220 of providing for building a data model based at least in part on the one or more of the user interactions, the contextual characteristics, and the selectable segments may be conducted by means, such as the data model builder 86, the monitoring module 80, the contextual characteristic determiner 84, the communication interface 74, and/or the processor 70.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising at least one processor and at least one memory including computer program code, the at least one memory and the computer program code configured to, with the processor, cause the apparatus to:
provide for selection of a content package comprising one or more selectable segments;
insert a script into the content package; and
monitor one or more user interactions with the selectable segments as directed by the script.

2. The apparatus of claim 1, further configured to receive a request for monitoring the user interactions from an application; and
draft the script based on the request.

3. The apparatus of claim 2, further configured to receive a second request for monitoring the user interactions from a second application; and
draft the script based on both the request and the second request.

4. The apparatus of claim 1, further configured to determine one or more contextual characteristics relating to the user interactions.

5. The apparatus of claim 4, further configured to provide for transmission of at least one of the user interactions, the contextual characteristics, and the selectable segments.

6. The apparatus of claim 4, further configured to provide for building a data model based at least in part on one or more of the user interactions, the contextual characteristics, and the selectable segments.

7. The apparatus of claim 1, further comprising user interface circuitry configured to:
facilitate user control of at least some functions of the apparatus through use of a display; and
cause at least a portion of a user interface of the apparatus to be displayed on the display to facilitate user control of at least some functions of the apparatus.

8. A method, comprising:
providing for selection of a content package comprising one or more selectable segments;
inserting a script into the content package; and
monitoring one or more user interactions with the selectable segments via a processor as directed by the script.

9. The method of claim 8, further comprising receiving a request for monitoring the user interactions from an application; and
drafting the script based on the request.

10. The method of claim 9, further comprising receiving a second request for monitoring the user interactions from a second application; and
drafting the script based on both the request and the second request.

11. The method of claim 8, further comprising determining one or more contextual characteristics relating to the user interactions.

12. The method of claim 11, further comprising providing for transmission of at least one of the user interactions, the contextual characteristics, and the selectable segments.

13. The method of claim 11, further comprising providing for building a data model based at least in part on one or more of the user interactions, the contextual characteristics, and the selectable segments.

14. The method of claim 8, further comprising inserting the script into the content package after the content package is selected.

15. A computer program product comprising at least one computer-readable storage medium having computer-executable program code portions stored therein, the computer-executable program code portions comprising:
program code instructions providing for selection of a content package comprising one or more selectable segments;
program code instructions for inserting a script into the content package; and
program code instructions for monitoring one or more user interactions with the selectable segments as directed by the script.

16. The computer program product of claim 15, further comprising:
program code instructions for receiving a request for monitoring the user interactions from an application; and
program code instructions for drafting the script based on the request.

17. The computer program product of claim 16, further comprising program code instructions for receiving a second request for monitoring the user interactions from a second application; and
program code instructions for drafting the script based on both the request and the second request.

18. The computer program product of claim 15, further comprising program code instructions for determining one or more contextual characteristics relating to the user interactions.

19. The computer program product of claim 18, further comprising program code instructions providing for building a data model based at least in part on one or more of the user interactions, the contextual characteristics, and the selectable segments.

20. The computer program product of claim 15, further comprising program code instructions for inserting the script into the content package after the content package is selected.
